(19) United States
(12) Patent Application Publication
(10) Pub. No.: US 2023/0281738 A1
(43) Pub. Date: Sep. 7, 2023

(54) Blockchain Homeshare Data Aggregator Solution

(71) Applicant: STATE FARM MUTUAL AUTOMOBILE INSURANCE COMPANY, Bloomington, IL (US)

(72) Inventors: Justin Davis, Normal, IL (US); Ryan Gammelgard, Bloomington, IL (US)

(21) Appl. No.: 17/707,474

(22) Filed: Mar. 29, 2022

Related U.S. Application Data
(60) Provisional application No. 63/316,143, filed on Mar. 3, 2022.

(51) Int. Cl. G06Q 50/16; G06Q 30/06; G06Q 20/38

(52) U.S. Cl. CPC G06Q 50/163; G06Q 30/0645; G06Q 20/389

(57) ABSTRACT

Systems and methods are described for generating transactions based upon homeshare data and updating a distributed ledger. The method may include: (1) identifying a homeshare company through which a user rents out at least part of a real property during a time period; (2) identifying a rental phase of the at least part of the real property for the homeshare company during the time period; (3) determining homeshare data for the user; (4) generating a transaction including a representation of the homeshare data; and/or (5) transmitting the transaction to at least one other participant of the plurality of participants maintaining the distributed ledger. The homeshare data from the distributed ledger for the user may be used to calculate a level of risk when the user is renting out the at least part of the real property.

### CROSS-REFERENCE TO RELATED APPLICATION

This application claims priority to and the benefit of the filing date of provisional U.S. Patent Application No. 63/316,143 entitled “BLOCKCHAIN HOMESHARE DATA AGGREGATOR SOLUTION,” filed on Mar. 3, 2022. The entire contents of the provisional application are hereby expressly incorporated herein by reference.

### FIELD OF THE DISCLOSURE

Systems and methods are disclosed for using a blockchain for recording homeshare information and determining a level of risk for a user based upon at least the recorded homeshare information.

### BACKGROUND

Renters for homeshare or other rental services may require protection in case of accidents or damage to properties that the renters rent out. Homeshare companies may purchase, provide, or otherwise have protection policies for the property while a customer is renting the property, but may have to rely on self-reporting to determine whether the renter or a customer of the homeshare company was in control and/or was the cause of any damage at the time of an accident. Self-reporting may become particularly difficult to track when a renter rents out a property to multiple parties in short succession, rents out property with some overlap in rental periods, and/or rents out portions of a property through different homeshare companies. As such, fraudulent reporting may be difficult to detect, and self-reporting may confuse or obfuscate a determination as to which company had control over the property, if any. Therefore, a method for securely and accurately tracking homeshare data is needed.

### SUMMARY

In one aspect, a computer-implemented method for generating transactions based upon homeshare data for a user and updating a distributed ledger maintained by a plurality of participants may be provided. The method may be implemented via one or more local or remote processors, servers, transceivers, sensors, memory units, and/or other electronic or electrical components. The method may include: (1) identifying, by one or more processors and/or associated transceivers, a homeshare company through which a user rents out at least part of a real property during a time period; (2) identifying, by the one or more processors and/or associated transceivers, a rental phase of the at least part of the real property for the homeshare company during the time period; (3) determining, by the one or more processors, homeshare data for the user, wherein the homeshare data may include the rental phase of the at least part of the real property for the homeshare company during the time period; (4) generating, by the one or more processors, a transaction including a representation of the homeshare data, wherein the transaction is stored in the distributed ledger; and/or (5) transmitting, by the one or more processors and/or associated transceivers, the transaction to at least one other participant of the plurality of participants maintaining the distributed ledger. The distributed ledger may maintain a record of users and the homeshare company for which each user rents out at least part of a respective real property, and homeshare data from the distributed ledger for the user may be used to calculate a level of risk when the user is renting out the at least part of the real property. The method may include additional, less, or alternate actions, including those discussed elsewhere herein.

For instance, the method further may include retrieving, from a computing device of a renter of the at least part of the real property, renter data. The renter data may be indicative of a property state of the at least part of the real property, and the transaction further may include a representation of the renter data.

In some embodiments, the homeshare company may be a first homeshare company of a plurality of homeshare companies and the homeshare data may include a rental phase of the at least part of the real property for each homeshare company of the plurality of companies. In other embodiments, the homeshare company may be a plurality of homeshare companies, and the method further may include: determining, based upon the homeshare data, an active homeshare company, wherein the active homeshare company is the homeshare company through which the user rents out the at least part of the real property during the time period, and the rental phase is a rental phase of the active homeshare company.

The method may include: (i) adding the transaction to a block of transactions; (ii) solving a cryptographic puzzle based upon the block of transactions; (iii) adding the solution to the cryptographic puzzle to the block of transactions; and/or (iv) transmitting the block of transactions to at least one other participant in the distributed ledger network.

In certain embodiments, generating the transaction may include generating a transaction including a cryptographic hash value corresponding to the homeshare data, and the method further may include transmitting the homeshare data to a server computing device that calculates the level of risk based upon the homeshare data. Transmitting the transaction may include transmitting, by the one or more processors and/or transceivers, the transaction to an address that stores a smart contract on the distributed ledger, and the smart contract calculates the level of risk based upon the homeshare data collected over the period of time.

In another aspect, a computing device for generating transactions based upon homeshare data for a user and updating a distributed ledger maintained by a plurality of participants may be provided. The computing device may include one or more local or remote processors, memory units, servers, sensors, transceivers, and other electronic or electrical components. The computing device may also include a communication unit, and a non-transitory computer-readable medium coupled to the one or more processors, with the communication unit and storing instructions thereon that, when executed by the one or more processors, cause the computing device to: (1) identify a homeshare company through which a user rents out at least part of a real property; (2) identify a rental phase of the at least part of the real property for the homeshare company during the time period; (3) determine homeshare data for the user, wherein the homeshare data may include the rental phase of the at least part of the real property for the homeshare company during the time period; (4) generate a transaction including a representation of the homeshare data, the transaction being stored in the distributed ledger; and/or (5) transmit the transaction to at least one other participant of the plurality of participants maintaining the distributed ledger. The distributed ledger may maintain a record of users and the homeshare company for which each user rents out at least part of a respective real property, and the homeshare data from the distributed ledger for the user may be used to calculate a level of risk when the user is renting out the at least part of the real property. The computing device may include additional, less, or alternate functionality, including that disclosed elsewhere herein.

For instance, the non-transitory computer-readable medium may further store instructions that, when executed by the one or more processors, cause the computing device to further: retrieve, from a computing device of a renter of the at least part of the real property, renter data. The renter data may be indicative of a property state of the at least part of the real property; and the transaction further may include a representation of the renter data.

In some embodiments, the homeshare company may be a first homeshare company of a plurality of homeshare companies and the homeshare data may include a rental phase of the at least part of the real property for each homeshare company of the plurality of companies.

Additionally or alternatively, the homeshare company may be a plurality of homeshare companies, and the non-transitory computer-readable medium may store instructions that, when executed by the one or more processors, cause the computing device to further determine, based upon the homeshare data, an active homeshare company. The active homeshare company may be the homeshare company through which the user rents out the at least part of the real property during the time period. The rental phase may be a rental phase of the active homeshare company.

In certain embodiments, the non-transitory computer-readable medium further stores instructions that, when executed by the one or more processors, may cause the computing device to: (i) add the transaction to a block of transactions; solve a cryptographic puzzle based upon the block of transactions; (ii) add the solution to the cryptographic puzzle to the block of transactions; and/or (iii) transmit the block of transactions to at least one other participant in the distributed ledger network.

Additionally, generating the transaction may include generating a transaction including a cryptographic hash value corresponding to the homeshare data, and the non-transitory computer-readable medium may store instructions that, when executed by the one or more processors, cause the computing device to transmit the homeshare data to a server computing device that calculates the level of risk based upon the homeshare data. Transmitting the transaction may include transmitting, by the one or more processors, the transaction to an address that stores a smart contract on the distributed ledger. The smart contract may calculate the level of risk based upon the homeshare data collected over the period of time.

In another aspect, a computer-implemented method of calculating a level of risk using aggregated homeshare data from a distributed ledger maintained by a plurality of participants may be provided. The method may be implemented via one or more local or remote processors, servers, transceivers, sensors, memory units, and/or other electronic or electrical components.

The method may include: (i) monitoring, by one or more processors and/or transceivers, the distributed ledger for an indication of homeshare data, the homeshare data including a rental phase of at least part of a real property that a user rents out through a homeshare company during a time period; (ii) determining, by the one or more processors and based upon the rental phase during the time period for the homeshare company, a level of risk for the user during the time period; and/or (iii) calculating, by the one or more processors, an overall level of risk for the user when the user is renting out the at least part of the real property based upon the homeshare data and the level of risk for the user during the time period. The method may include additional, less, or alternate actions, including those discussed elsewhere herein.

For instance, the level of risk may be attributable to the homeshare company when the rental phase of the at least part of the real property indicates the user is renting out the at least part of the real property through the homeshare company and is otherwise attributable to the user. In some embodiments, the homeshare company may be a first homeshare company of a plurality of homeshare companies and the homeshare data may include a rental phase of the at least part of the real property for each homeshare company of the plurality of companies.

The method further may include determining, based upon the homeshare data, an active homeshare company. The active homeshare company may be the homeshare company through which the user rents out the at least part of the real property during the time period, and the overall level of risk may be further based upon the active homeshare company.

The method may also include retrieving, from a computing device of a renter of the at least part of the real property, renter data. The renter data may be indicative of a property state of the at least part of the real property, and the overall level of risk may be further based upon the renter data.

The method further may include monitoring the distributed ledger for an indication for an indication of renter data from a renter of the at least part of the real property. The renter data may be indicative of a property state of the at least part of the real property, and the overall level of risk may be based upon the renter data.

This summary is provided to introduce a selection of concepts in a simplified form that are further described in the Detailed Descriptions. This summary is not intended to identify key features or essential features of the claimed subject matter, nor is it intended to be used to limit the scope of the claimed subject matter.

Advantages will become more apparent to those of ordinary skill in the art from the following description of the preferred aspects, which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

FIG. 1 depicts an exemplary computer system that facilitates generating and recording homeshare data for calculating a level of risk, and transmitting the homeshare data to a distributed ledger network.

FIG. 2 depicts an exemplary distributed ledger system for recording transactions and executing smart contracts related to homeshare data, in accordance with one aspect of the present disclosure.

FIG. 3 depicts exemplary validating network nodes and an exemplary transaction flow on a distributed ledger network related to homeshare data, in accordance with one aspect of the present disclosure.

FIG. 4 depicts exemplary components of a network node on a distributed ledger network related to homeshare data, in accordance with one aspect of the present disclosure.

FIG. 5A depicts an exemplary transaction representing homeshare data generated by a computing device associated with the property, a smart device, or a mobile device communicatively coupled to the property.

FIG. 5B depicts an exemplary smart contract state in a distributed ledger network for generating a level of risk for a property.

FIG. 6 depicts a flow diagram representing an exemplary computer-implemented method for recording homeshare data using a distributed ledger.

FIG. 7 depicts a flow diagram representing an exemplary computer-implemented method for determining a level of risk using recorded homeshare data on a distributed ledger.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Techniques, systems, apparatuses, components, devices, and methods are disclosed for utilizing a distributed ledger, or blockchain, to record homeshare data. For example, a distributed ledger may be maintained by nodes, such as computing devices associated with insurance companies, property rental companies, regulatory organizations, homeshare companies, and/or other organizations involved in determining the value of and/or risk associated with a property. The nodes may receive transactions broadcasted to a distributed ledger network from smart devices within properties or mobile devices communicatively coupled to computing devices associated with the properties.

In some scenarios, the transactions may include homeshare data which is indicative of one or more homeshare companies through which a user rents out property during a given time period. In further embodiments, the transactions may include homeshare data further indicative of what phase of a homeshare stay a property is in for each homeshare company during the given time period, also referred to herein as the “rental phase”.

More specifically, the homeshare data may include what rental phase the property is currently in with regards to a rentee (e.g., a renter who rents the property from the user): a rentee occupation phase, a rentee scheduled phase, a rentee search phase, or a resting phase depending on what the status of the property is via a particular homeshare company during the given time period. In some embodiments, the user may provide rental services through multiple homeshare companies, and the homeshare data may include an indication and/or identifier for each homeshare company through which the user provides such services.

Additionally or alternatively, the homeshare data may include additional data associated with a user. For example, the homeshare data may include a number of past rentees for the property owned by the user; an overall rating for the user, individual ratings for the user for individual stays; property registration information for the user; property damage information for the user; accident information for the property owned by the user; insurance information for the user; insurance information for each homeshare company with regard to the user; insurance rules for each homeshare company; rentee data for the rentee of a given stay; etc.

The computer system may then use homeshare data to calculate a level of risk for a user renting out a property via the homeshare companies. In some embodiments, the level of risk may indicate whether the user is covered under an insurance policy for at least one of the homeshare companies.

When the computer system determines the level of risk to be above a predetermined level—such as when the system determines that the user is not eligible for at least one insurance policy for the homeshare companies—the system may provide the user with an overall level of risk and/or customizable quote that the user may choose to purchase (e.g., a pay-per-day policy). For example, the system may determine that the user has a high level of risk for a brief period of time after a stay for one homeshare company ends, but switches rental phases for another homeshare company, dropping the overall level of risk to low. Alternatively, the system may determine that the overall level of risk is low, but may still provide the customizable quote to the user.

In certain embodiments, the computer system may transmit the homeshare data in a transaction to the distributed ledger network and to a server computing device for calculating the level of risk. To ensure that the server computing device uses reliable homeshare data, the server computing device may compare the homeshare data stored at the server computing device to the homeshare in the distributed ledger network. Furthermore, a party requesting the level of risk may receive the homeshare data alongside the requested item. The third-party may then verify the authenticity of the homeshare data used to generate the requested item by performing a comparison to the homeshare data in the distributed ledger.

Still further, the computer system may utilize distributed ledgers to execute smart contracts, described in more detail below. An organization involved in calculating a level of risk may deploy a smart contract to the distributed ledger to generate the level of risk calculation based upon the homeshare data. In some embodiments, the smart contract may require a requestor of the level of risk calculation to provide value in exchange for the calculated level of risk.

By utilizing distributed ledgers and, in some scenarios, smart contracts to record homeshare data and generate levels of risk, the computer system may provide a trusted, secure, and immutable record of the homeshare data. The secure, immutable, and trustless nature of distributed ledgers is particularly important in multiple homeshare company contexts, where the normal tools for reporting are spread across multiple company applications. As such, determining the proper level of risk may rely on self-reporting from a user, where fraudulent activity or reporting may greatly impact a homeshare company in question. Due to the automatic nature of the reporting and the difficulty of changing the recorded homeshare data in the distributed ledgers, interested entities do not have to trust that the data is reliable.

A blockchain (also referred to herein as a distributed ledger or a shared ledger) is a storage mechanism for data, events, transactions, etc. that several participants maintain. More specifically, a distributed ledger is a way of achieving a distributed consensus on the validity or invalidity of information in the distributed ledger. In other words, the blockchain may provide a decentralized trust to participants and observers.

As opposed to relying on a central authority, a blockchain is a decentralized database in which each node of a peer-to-peer network maintains and validates a transactional record of changes to the ledger. The distributed ledger is comprised of groupings of transactions organized together into a “block,” and ordered sequentially (hence the term “blockchain”). While the distributed ledgers discussed herein are referred to in the context of a blockchain, this is merely one example of a distributed ledger. Distributed ledgers may also include a tangle, a block lattice, or other directed acyclic graph (DAG).

In any event, nodes may join and leave the blockchain network over time and may obtain blocks that were propagated while the node was gone from peer nodes. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network, distributed homeshare ledger, homeshare ledger, etc. The nodes in the distributed ledger network may validate changes to the blockchain (e.g., when a new transaction and/or block is created) according to a set of consensus rules. The consensus rules may depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirement and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules may be propagated from nodes that have validated the addition to other nodes of which the validating node is aware. If all the nodes that receive a change to the blockchain validate the new block, then the distributed ledger may reflect the new change as stored on all nodes, and it may be said that distributed consensus has been reached with respect to the new block and the information contained therein. Validating nodes that receive any change that does not satisfy the consensus may disregard the change and do not propagate the change to other nodes.

Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable. Therefore, blockchains may remove potential attack vectors for tampering with the homeshare data, such as a centralized database maintained by an organization involved in determining the level of risk for a user.

The validation activities of nodes applying consensus rules on a blockchain network may take various forms. In one embodiment, the blockchain may appear as a shared spreadsheet that tracks data such as the homeshare data. In another embodiment, the validating nodes may execute code contained in “smart contracts” and distributed consensus may be expressed as the network nodes agreeing on the output of the executed code.

A smart contract is a computer protocol that enables the automatic execution and/or enforcement of an agreement between different parties. In particular, the smart contract may be computer code located at a particular address on the blockchain. In some cases, the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds stored at the address. In some scenarios, when the balance reaches zero, the smart contract may no longer be operational.

The smart contract may include one or more trigger conditions, that, when satisfied, may correspond to one or more actions. For some smart contracts, the computer system may determine to perform the action(s) based upon one or more decision conditions. In some instances, the system may route data streams to the smart contract so that the smart contract may detect that a trigger condition has occurred and/or analyze a decision condition.

The computer system may deploy blockchains in a public, decentralized, and permissionless manner, meaning that any party may view the shared ledger, submit new information to be added to the ledger, or join the network as a validating node. Other blockchains may be private (e.g., permissioned ledgers) and may keep chain data private among a group of entities authorized to participate in the blockchain network.

As noted above, the present embodiments may relate to systems and methods for using a blockchain to record and manage information related to homeshare data. The blockchain may be either a public or permissioned ledger.

### Exemplary Distributed Ledger for Calculating Risk, Verifying a Controlling Party, or Generating a Settlement Quote

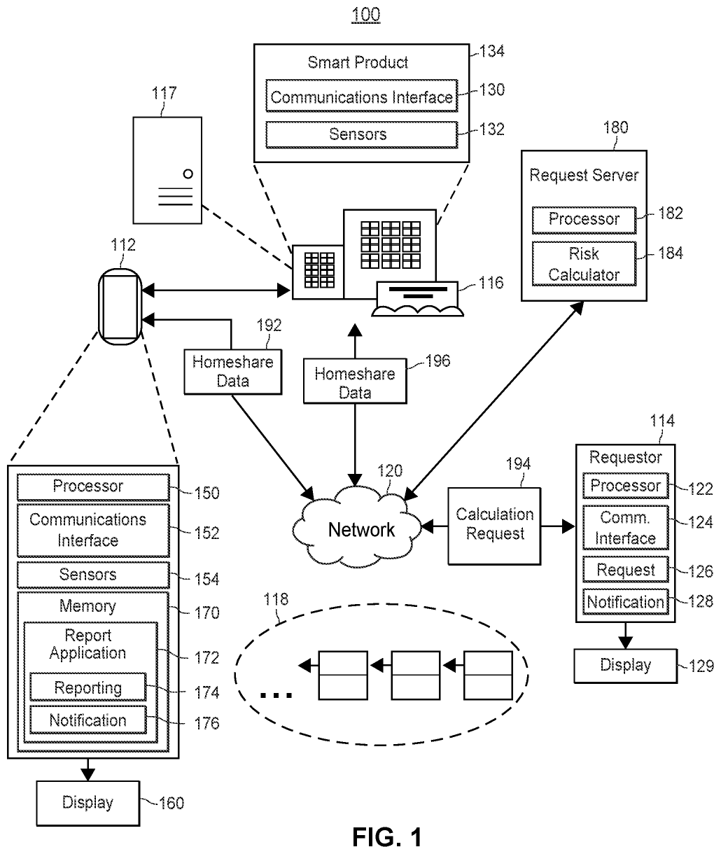

FIG. 1 depicts an exemplary distributed ledger system 100 for generating transactions based upon homeshare data for a user, updating a distributed ledger, and/or calculating a level of risk using aggregated homeshare data from the distributed ledger in accordance with various aspects of the present disclosure. An entity (e.g., requestor 114), such as a user or an insurance company, may wish to calculate a level of risk for a user regarding a real property (e.g., property 116).

Additionally, the property (e.g., property 116) and, more specifically, a computing device 117 associated with the property 116, a smart device 134 within the property 116, and/or one or more mobile devices may detect and store homeshare data associated with the functioning and/or operation of the property 116. The distributed ledger system 100 may include a blockchain 118 accessible by network participants via a network 120 (e.g., a private or public packet switched network). The computing device 117 associated with the property 116 may transmit homeshare data in transactions 196 to the blockchain 118. Additionally or alternatively, one or more mobile devices (e.g., mobile device 112) communicatively coupled to the computing device associated with the property 116 may transmit homeshare data in transactions 192 to the blockchain 118.

The smart device 134 may include a processor, a set of one or several sensors 132, and a communication interface 130. In some embodiments, the smart device 134 may include single devices, such as a smart television, smart refrigerator, smart doorbell, or any other similar smart device. In further embodiments, the smart device 134 may include a network of devices, such as a security system, a lighting system, or any other similar series of devices communicating with one another. The set of sensors 132 may include, for example, a camera or series of cameras, a motion detector, a temperature sensor, an airflow sensor, a smoke detector, a carbon monoxide detector, or any similar sensor.

Although FIG. 1 depicts the set of sensors 132 inside the smart device 134, it is noted that the sensors 132 need not be integral components of the smart device 134. Rather, a property may include any number of sensors in various locations, and the smart device 134 may receive data from these sensors during operation. In further embodiments, the computing device 117 associated with the property 116 may receive data from the sensors during operation. In still further embodiments, the computing device 117 associated with the property 116 may be the smart device 134.

The communication interface 130 may allow the smart device 134 to communicate with the mobile device 112, the sensors 132, and/or a computing device 117 associated with the property 116. The communication interface 130 may support wired or wireless communications, such as USB, Bluetooth, Wi-Fi Direct, Near Field Communication (NFC), etc. The communication interface 130 may allow the smart device 134 to communicate with various content providers, servers, the blockchain network, etc., via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc. The processor may operate to format messages transmitted between the smart device 134 and the mobile device 112, sensors 132, and/or computing device 117 associated with the property 116; process data from the sensors 132; transmit transactions to the blockchain network; etc.

Mobile device 112 may be associated with (e.g., in the possession of, configured to provide secure access to, etc.) a particular user, who may be an owner of a property, such as property 116. Mobile device 112 may be a personal computing device of that user, such as a smartphone, a tablet, smart glasses, or any other suitable device or combination of devices (e.g., a smart watch plus a smartphone) with wireless communication capability. In the embodiment of FIG. 1, mobile device 112 may include a processor 150, a communications interface 152, sensors 154, a memory 170, and a display 160.

Processor 150 may include any suitable number of processors and/or processor types. Processor 150 may include one or more CPUs and one or more graphics processing units (GPUs), for example. Generally, processor 150 may be configured to execute software instructions stored in memory 170. Memory 170 may include one or more persistent memories (e.g., a hard drive and/or solid state memory) and may store one or more applications, including report application 172.

The mobile device 112 may be communicatively coupled to the smart device 134, the sensors 132, and/or a computing device 117 associated with the property 116. For example, the mobile device 112 and the smart device 134, sensors 132, and/or computing device 117 associated with the property 116 may communicate via USB, Bluetooth, Wi-Fi Direct, Near Field Communication (NFC), etc. For example, the smart device 134 may send homeshare data or other sensor data in the property 116 via communications interface 130 and the mobile device 112 may receive the homeshare data or other sensor data via communications interface 152. In other embodiments, mobile device 112 may obtain the homeshare data from the property 116 from sensors 154 within the mobile device 112.

Further still, mobile device 112 may obtain the homeshare data via a user interaction with a display 160 of the mobile device 112. For example, a user may take a photograph indicative of a property and/or input information regarding a stay indicative of homeshare data at the display 160. Reporting unit 174 may be configured to prompt a user to take a photograph or input information at the display 160. The mobile device 112 may then generate a transaction that may include the homeshare data and may transmit the transaction 192 to the blockchain network via communications interface 152.

In some embodiments, the report application 172 may include or may be communicatively coupled to a homeshare application. In such embodiments, the mobile device 112 may obtain the homeshare data via stored data in the homeshare application or via a notification 176 in the report application 172 granting the report application 172 access to the homeshare application data.

Depending on the embodiment, a computing device 117 associated with the property 116 may obtain homeshare data for the property 116 indicative of housing conditions, property condition, renter condition, rentee condition, or other similar metrics of homeshare data. The computing device 117 associated with the property 116 may obtain the homeshare data from one or more sensors 132 within the property 116. In other embodiments, the computing device 117 associated with the property 116 may obtain homeshare data through interfacing with a mobile device 112. Homeshare data may include data indicative of an accident or damage to the property 116.

Depending on the embodiment, homeshare data may be indicative of both visible and invisible damage to the property. For example, the homeshare data may include image data of the property as well as internal diagnostic data on functionality of particular devices or components of the property 116. In another example, homeshare data may be used to determine that the property 116 and/or components of the property 116 are likely to require repair and/or replacement.

In some embodiments, the homeshare data may include interpretations of raw sensor data, such as detecting an intruder event when a sensor detects motion during a particular time period. The computing device 117 associated with the property 116, mobile device 112, and/or smart device 134 may collect and transmit homeshare data to the blockchain network in real-time or at least near real-time at each time interval in which the system 100 collects homeshare data. In other embodiments, a component of the system 100 may collect a set of homeshare data at several time intervals over a time period (e.g., a day), and the smart device 134, computing device 117 associated with the property 116, and/or mobile device 112 may generate and transmit a transaction which may include the set of homeshare data collected over the time period.

Also, in some embodiments, the smart device 134, computing device 117 associated with the property 116, and/or mobile device 112 may generate and transmit transactions periodically (e.g., every minute, every hour, every day), where each transaction may include a different set of homeshare data collected over the most recent time period. In other embodiments, the smart device 134, computing device 117 associated with the property 116, and/or mobile device 112 may generate and transmit transactions as the smart device 134, mobile device 112, and/or computing device 117 associated with the property 116 receive new homeshare data.

In further embodiments, a trusted party may collect and transmit the homeshare data, such as an evidence oracle. The evidence oracles may be devices connected to the internet that record and/or receive information about the physical environment around them, such as a smart device 134, a mobile device 112, sensors 132, a homeshare company server, etc. In further examples, the evidence oracles may be devices connected to sensors such as connected video cameras, motion sensors, environmental conditions sensors (e.g., measuring atmospheric pressure, humidity, etc.) as well as other Internet of Things (IoT) devices.

The data may be packaged into a transaction, such as transaction 192 or 196. The data from the evidence oracle may include a transaction ID, an originator (identified by a cryptographic proof-of-identity, and/or a unique oracle ID), an evidence type, such as video and audio evidence, and a cryptographic hash of the evidence. In another embodiment, the evidence is not stored as a cryptographic hash, but may be directly accessible by an observer or other network participant.

Next, the smart device 134 and/or computing device 117 associated with the property 116 may generate a transaction 196 including a representation of the homeshare data wherein the transaction 196 is stored in the blockchain 118. When entities broadcast transactions to the blockchain 118, a proof-of-identity of the entity broadcasting the transaction may accompany the transaction.

In one embodiment, the entity broadcasting the transactions may include a cryptographic proof-of-identity in transactions sent to the blockchain. For example, each of the entities 112, 117, and 134 may own private cryptographic keys that are associated with public cryptographic keys known to belong to the entity (e.g., public cryptographic keys associated with each of the entities may be published by a trusted third party or proven to other network participants, etc.).

An entity wishing to broadcast a transaction to the blockchain 118 may sign a cryptographic message in the transaction with the entity's private cryptographic key to prove the identity of the entity broadcasting the transaction. In this way, other network participants may receive cryptographic proof that the participating entity originated the information contained in the broadcast transaction.

Accordingly, generating the transaction 196 may include obtaining identity data for the smart device 134, computing device 117, and/or the property 116; obtaining identity data for the mobile device 112 in the property 116; and/or augmenting the transaction 196 with the identity data for the smart device 134, the property 116, the computing device 117, and/or the mobile device 112. The transaction 196 may include the homeshare data or a cryptographic hash value corresponding to the homeshare data.

Next, the smart device 134 and/or computing device 117 associated with the property 116 may transmit, for example via communications interface 130 or communications interface 152, the transaction 196 to at least one other participant in a distributed ledger network of participants maintaining the distributed ledger. Additionally or alternatively, mobile device 112 may (i) obtain homeshare data; (ii) generate a transaction 192 including a representation of the homeshare data wherein the transaction 192 is stored in the blockchain 118; and/or (iii) transmit the transaction 192 to at least one other participant in a distributed ledger network of participants. The transaction 192 may include the homeshare data or a cryptographic hash value corresponding to the homeshare data.

Further still, a third party device, such as a third party server (not pictured), may obtain homeshare data (e.g., from the computing device 117 and/or the mobile device 112), generate a transaction including a representation of the homeshare data wherein the transaction is stored in the blockchain 118, and transmit the transaction to at least one other participant in a distributed ledger network of participants. The transaction 192 may include the homeshare data or a cryptographic hash value corresponding to the homeshare data.

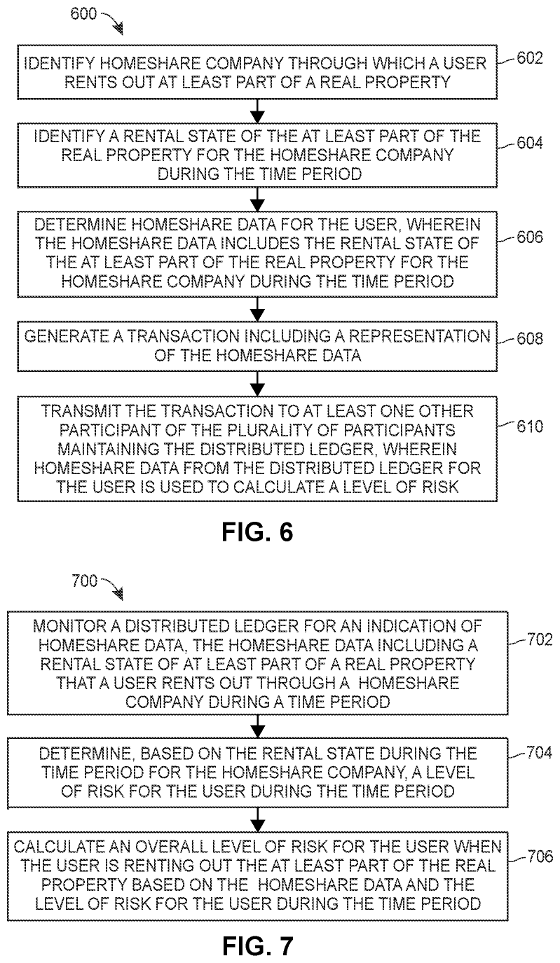

In some embodiments, in addition to transmitting the homeshare data to at least one other participant in a distributed ledger network of participants, the mobile device 112 or the smart device 134 may transmit the homeshare data to a request server 180. The request server 180 may include a processor 182 and a memory that stores various applications for execution by the processor 182. For example, a risk calculator 184 may obtain homeshare data for a user to analyze and calculate a risk for a user and/or homeshare company during a particular time period in response to a calculation request 194, as described in more detail below with regard to FIG. 7.

In some such embodiments, the risk calculator 184 obtains the sets of homeshare data for the property from the blockchain 118. The risk calculation may include a set of homeshare data used to generate the calculation.

Additionally, the blockchain 118 may include cryptographic hash values corresponding to the set of homeshare data used to generate each output. To verify the authenticity of the set of homeshare data used, the requestor 114 may compare the set of homeshare data included in the report to the corresponding cryptographic hash values in the blockchain 118. If the set of homeshare data used to generate the respective output does not match with the corresponding cryptographic hash values in the blockchain 118, the requestor 114 may determine that an outside party has tampered with the homeshare data. Otherwise, if the set of homeshare data used to generate the report matches with the corresponding cryptographic hash values in the blockchain 118, the requestor 114 may determine that the homeshare data is valid and that the calculation is an accurate output.

In some embodiments, the level of risk calculation may include a determination as to the level of coverage required for a user during a given time period. As such, the level of risk in such embodiments may depend on what rental phase a homeshare stay is in for each company. In further embodiments, the level of risk may depend on additional factors, such as compliance with homeshare company standards, a period of time before or after a stay starts or ends, location data, and other similar factors.

In some embodiments, the level of risk may refer to a level of risk for a particular time period, and a level of risk for a larger time period may be referred to as an overall level of risk. The overall level of risk may be calculated based upon the level of risk and homeshare data.

Additionally or alternatively, the overall level of risk may include a determination of a proper customizable policy quote for the user during the time period. In still further embodiments, the overall level of risk may include a determination of a customizable policy quote for a longer period of time, such as a month, year, etc.

In some embodiments, a mobile device 112 may stream the homeshare data to a node of the blockchain 118 and/or the network 120 in real or near-real time. For example, the mobile device and/or a reporting application 172 on the mobile device 112 may update the node of the blockchain 118 and/or the network 120 whenever a new event occurs with regard to a homeshare application and/or stay (e.g., upon the start of a new stay, upon the end of a stay, upon finding a rentee, upon receiving a user rating from a profile, upon rating a rentee, etc.). In further embodiments, the mobile device 112 may receive confirmations of updated information and may notify the user that the mobile device 112 has updated the blockchain 118 and/or network 120.

Optionally, the system 100 may determine homeshare data for the level of risk calculation based upon a machine learning model. The machine learning model may be trained based upon a plurality of sets of homeshare data and corresponding levels of risk. The machine learning model may use the homeshare data to generate the level of risk.

In other embodiments, as an alternative to the request server 180 generating the level of risk, the system 100 may deploy a smart contract to the blockchain 118 and/or network 120 to generate the risk calculation. Any participant in the blockchain network may deploy the smart contract, and the smart contract may expose methods and data to other participants in the blockchain network. The smart contract may obtain homeshare data for a user and may generate a risk calculation based upon the homeshare data. Some of the data in the smart contract state may be private data that may only be altered by calling a method of the smart contract, or only altered by authorized blockchain participants.

In one embodiment, the system 100 may alter the smart contract state by broadcasting a transaction to the distributed ledger network. If the broadcasted transaction satisfies consensus rules, network validators may include the transaction in a block. Inclusion in the blockchain of a transaction sending data to the smart contract may cause validating nodes to update a state database for the smart contract. Therefore, the validating nodes may allow network participants access to a rich state mechanism to manage the analysis of the homeshare data, and ultimately to generate the risk calculation. In this embodiment, transmitting a transaction (e.g., transactions 196 or 192) may include transmitting the transaction to an address that stores the smart contract on the blockchain 118.

In response to transmitting a transaction to the blockchain network, a validating node may add the transaction (e.g., transactions 196 or 192) to a block of transactions. Adding the transaction 196 and/or 192 to a block of transactions may include solving a cryptographic puzzle based upon the block of transactions, adding the solution to the cryptographic puzzle to the block of transactions, and transmitting the block of transactions to at least one other participant in the distributed ledger network.

In some embodiments, to cryptographically link blocks and transactions together, each block in the blockchain 118 may organize transactions into a Merkle Tree. In a Merkle Tree, the respective block hashes each transaction according to a cryptographic hashing algorithm (e.g., SHA-256) and then combines the resulting output hash with the hash of another transaction. Then the respective block hashes the combined result according to the cryptographic hashing algorithm. The block then combines the output with the hash of two other transactions and this process is repeated until all of the transactions in the block are combined and hashed to generate a Merkle root that is used in the header for a block. If any single transaction in the block is tampered with, a different Merkle root would be generated since the Merkle root is a combination of the hashes of all of the transactions in the block.

In other words, the computer system 100 may hash the transactions using a cryptographic hash algorithm, such as the algorithms discussed above, and the system 100 may store the hash of each transaction in the tree. As the system 100 constructs the tree, the block may hash together the hash of each adjacent node at the same level to create a new node that exists at a higher level in the tree. Therefore, the node at the top of the tree or Merkle root, may be dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

To verify that a block is valid, a node may compare the Merkle root of the block to the Merkle root for the same block included in other nodes' copies of the blockchain. Therefore, the Merkle root may be proof of the transactions included in the block and proof that the contents of the block have not been tampered with if the Merkle root is the same in each node's copy of the block.

In one embodiment, documents stored “on” a blockchain are documents that have been hashed according to a cryptographic hashing algorithm (e.g., SHA-256) and the resulting output hash has been included in a transaction in a block that has been accepted by the network nodes as satisfying the consensus rules of the blockchain. As such, the documents may be later verified or validated by comparing the hash of the documents to the hash stored on the blockchain. For example, if a set of documents results in a SHA-256 hash recorded on a blockchain on a certain date, then the blockchain may provide cryptographic proof that the documents existed as of that date.

In some embodiments, the system 100 may store a document on a blockchain by broadcasting a transaction including a hash of the document to the network, which a component of the system 100 may include in a block if the transaction satisfies all of the consensus rules of the network. In some embodiments, the blockchain may be a permissioned ledger, meaning only authorized network participants may broadcast transactions.

In other embodiments, only some authorized network participants may make certain transactions. For example, the computing device 117, smart device 134, and/or the mobile device 112 may upload the homeshare data to the blockchain 118. Only a cryptographic hash of the data may be included in the blockchain 118 such that the blockchain may verify the data even if a party off-chain obtains the data.

Validating network nodes may verify that the signed transaction or signed message was signed by the private cryptographic key corresponding to the published public cryptographic key. In at least one embodiment, the blockchain network may apply a valid proof-of-identity as a consensus rule. As such, the network may reject any transaction attempting to add new homeshare data to the blockchain without a cryptographic proof-of-identity matching an identity authorized to add new homeshare data as non-compliant with the consensus rule. Each smart device 134, computing device 117, and/or mobile device 112 may be assigned a public key/private key pair which is identified in the blockchain network as corresponding to the smart device 134, computing device 117, and/or mobile device 112. If the validating network nodes receive a transaction regarding homeshare data that is not from an authorized smart device 134, computing device 117, and/or mobile device 112, the validating network nodes may reject the transaction.

The mobile device 112 and the computing device 117 associated with the property 116 may be associated with the same user. Mobile device 112, and optionally the computing device 117 associated with the property 116, may be communicatively coupled to requestor 114 via a network 120. Network 120 may be a single communication network, or may include multiple communication networks of one or more types (e.g., one or more wired and/or wireless local area networks (LANs), and/or one or more wired and/or wireless wide area networks (WANs) such as the internet). In some implementations, the requestor 114 may connect to the network 120 via a communications interface 124 much like mobile device 112. Similarly to mobile device 112, the requestor 114 may include processors 122 by which the requestor may receive requests and transmit notifications 128, as well as a display 129.

While FIG. 1 shows only one mobile device 112, it is understood that many different mobile devices (of different users), each similar to mobile device 112, may be in remote communication with network 120. Additionally, while FIG. 1 shows only one property 116 and associated computing device 117, it is understood that many different entity locations, each similar to property 116, may include computing devices 117 that are in remote communication with network 120.

Further, while FIG. 1 shows only one requestor, 114, it is understood that many different requestors, each similar to requestor 114, may be in remote communication with network 120. Requestor 114 and/or any other participant maintaining the blockchain 118 may be an insurance company, a regulator organization, a property rental company, and/or a similar organization.

It will be understood that the above disclosure is one example and does not necessarily describe every possible implementation. As such, it will be further understood that alternate embodiments may include fewer, alternate, and/or additional steps or elements.

### Exemplary Validating Nodes in a Distributed Ledger System for Calculating Risk Associated with Users and Properties

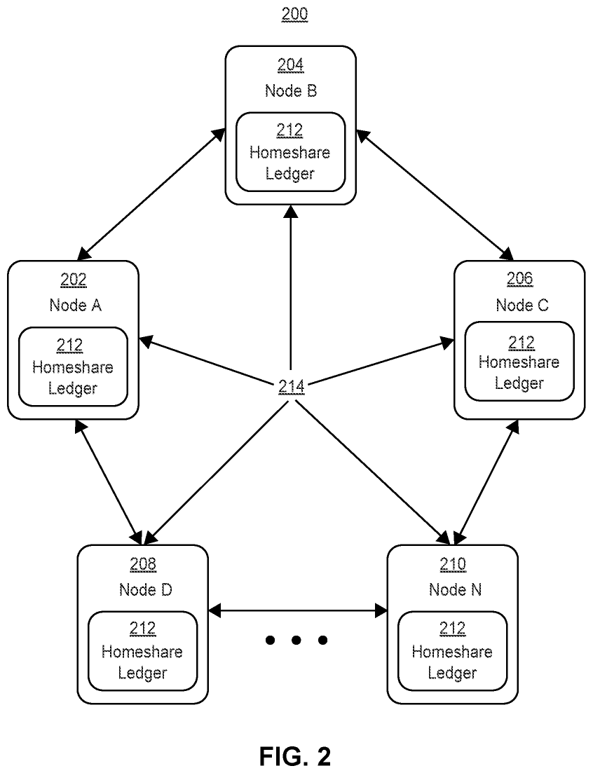

FIG. 2 depicts an exemplary distributed ledger system 200 for generating transactions based upon homeshare data for a user, updating a distributed ledger, and/or calculating a level of risk using aggregated homeshare data from the distributed ledger in accordance with various aspects of the present disclosure. The system 200 may include a distributed property homeshare ledger 212 and plurality of nodes 202, 204, 206, 208, and 210. Each node maintains a copy of the property homeshare ledger 212. As changes are made to the property homeshare ledger 212, each node receiving the change via network 214 may update the respective copy of the distributed property homeshare ledger 212 stored on the node. In some embodiments, the network 214 may be or may include the blockchain 118 of FIG. 1. A consensus mechanism may be used by the nodes 202-210 in the distributed ledger system 200 to decide whether the nodes 202-210 may make received changes to the property homeshare ledger 212.

Each node in the system therefore may have a copy of the property homeshare ledger 212, which is identical to every other copy of the property homeshare ledger 212 stored by the other nodes. The distributed ledger system 200 is more robust than a central authority database system because of the distributed ledger's decentralized nature. As such, there is no single point of failure on the distributed ledger system 200 as there would be in a centralized system.

It will be understood that the above disclosure is one example and does not necessarily describe every possible implementation. As such, it will be further understood that alternate embodiments may include fewer, alternate, and/or additional steps or elements.

### Exemplary Transaction Flow & Block Propagation Flow

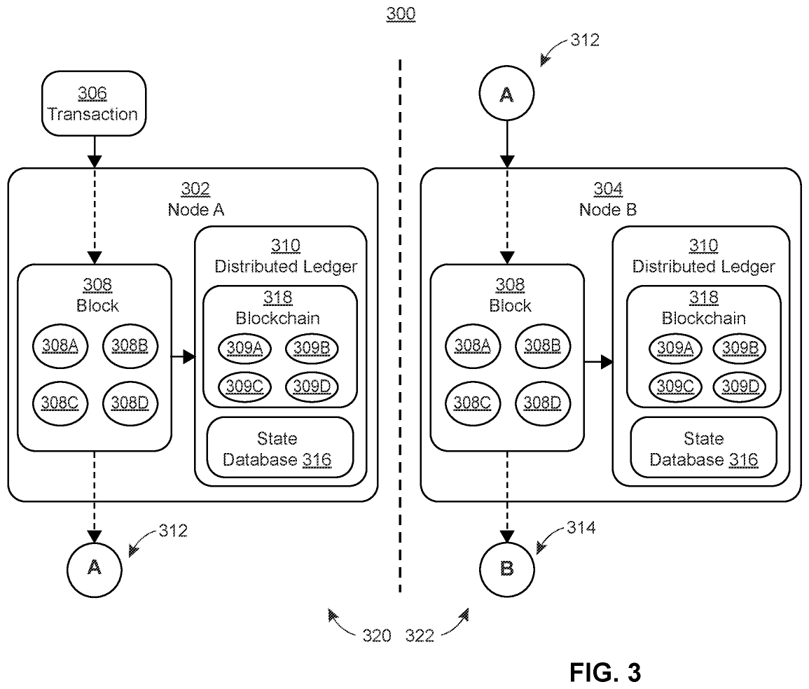

FIG. 3 depicts exemplary validating network nodes and an exemplary transaction flow 300 on a distributed ledger network for generating transactions based upon homeshare data for a user, updating a distributed ledger, and/or calculating a level of risk using aggregated homeshare data from the distributed ledger in accordance with various aspects of the present disclosure. FIG. 3 may include two time frames 320 and 322 represented by the left and right sides of the dotted line, respectively, Node A 302 and Node B 304, a set of transactions 308A-308D, a set of blocks of transactions 309A-309D, a distributed ledger 310, a state database 316, and a blockchain 318.

The block propagation flow 300 may begin with Node A 302 receiving transaction 306 at time 320. When Node A 302 confirms that transaction 306 is valid, the Node A 302 may add the transaction 306 to a newly generated block 308. As part of adding the transaction 306 to block 308, Node A 302 may solve a cryptographic puzzle and may include the solution in the newly generated block 308 as proof of the work done to generate the block 308. In other embodiments, Node A 302 may add the transaction 306 to a pool of transactions until a sufficient number of transactions in the pool exist to form a block 308. Node A 302 may then transmit the newly created block 308 to the network at 312. Before or after propagating the block 308, Node A 302 may add the block 308 to its copy of the blockchain 318.

The transactions 309A-309D may include updates to a state database 316. The state database 316 may contain current values of variables created by smart contracts deployed on the blockchain 318. Validated blocks such as block 308 may include transactions affecting state variables in state database 316. At time 322 Node B 304 may receive the newly created block 308 via the network at 312. Node B 304 may verify that the block of transactions 308 is valid by checking the solution to the cryptographic puzzle provided in the block 308. If the solution is accurate, then Node B 304 may add the block 308 to its blockchain 318 and make any updates to the state database 316 as required by the transactions in block 308. Node B 304 may then transmit the block 308 to the rest of the network at 314.

It will be understood that the above disclosure is one example and does not necessarily describe every possible implementation. As such, it will be further understood that alternate embodiments may include fewer, alternate, and/or additional steps or elements.

### Exemplary Node

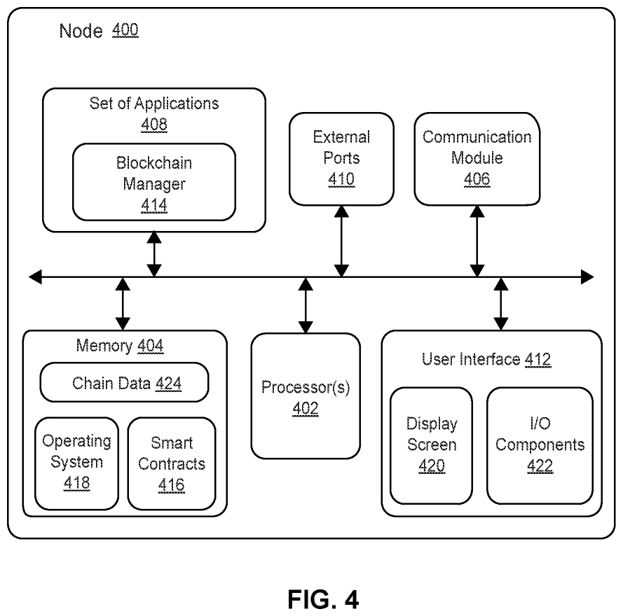

FIG. 4 depicts exemplary components of a network node 400 on a distributed ledger network for generating transactions based upon homeshare data for a user, updating a distributed ledger, and/or calculating a level of risk using aggregated homeshare data from the distributed ledger in accordance with various aspects of the present disclosure. Node 400 may be capable of performing the functionality disclosed herein. Node 400 may include at least one processor 402, memory 404, a communication module 406, a set of applications 408, external ports 410, user interface 412, a blockchain manager 414, smart contracts 416, operating system 418, a display screen 420, and input/output components 422.

In some embodiments, the node 400 may generate a new block of transactions or may broadcast transactions to other network nodes by using the blockchain manager 414. Similarly, the node 400 may use the blockchain manager 414 in conjunction with the smart contracts 416 stored in memory 404 to execute the functionality disclosed herein. The memory 404 may further include chain data 424 including, for example, a state database of the blockchain for storing state of smart contracts deployed thereon.

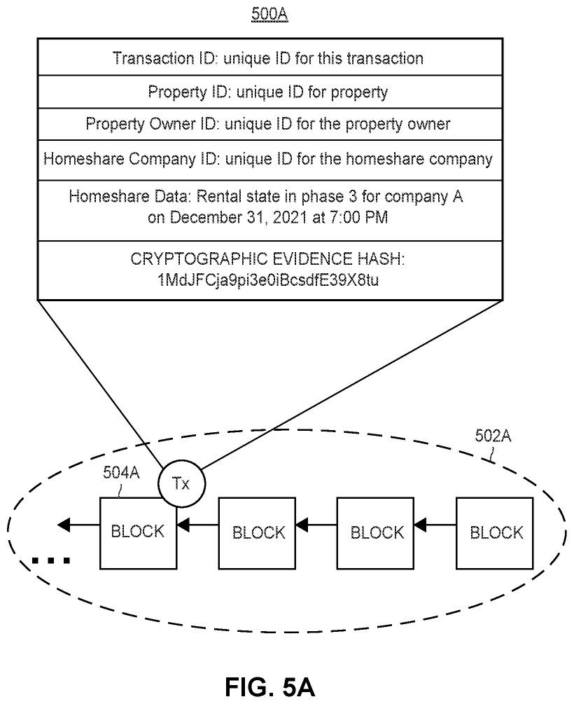

In other embodiments, the smart contracts 416 may operate independently of the blockchain manager 414 or other applications. In some embodiments, node 400 may not have a blockchain manager 414, or smart contracts 416 stored at the node. The components of the node 400 are described in more detail above with regard to FIG. 1 and below with regard to FIGS. 5A and 5B.

The node 400, as part of a decentralized ledger system 100, or another decentralized or centralized network, may be used as part of systems that interact with and/or manipulate data and transactions associated with the homeshare data aggregation process and the risk calculation process.

It will be understood that the above disclosure is one example and does not necessarily describe every possible implementation. As such, it will be further understood that alternate embodiments may include fewer, alternate, and/or additional steps or elements.

### Exemplary Homeshare Transaction

FIG. 5A depicts an exemplary transaction 500A on a distributed ledger network for updating a distributed ledger and/or calculating a level of risk in accordance with aspects of the present disclosure. A smart device 134 within a property 116 or by a mobile device 112 associated with the property 116 and/or an owner of the property 116 may generate the transaction 500A. In some embodiments, the mobile device 112 may be communicatively coupled to a computing device representative of the property and/or a smart device 134 within the property 116. When the smart device 134 and/or mobile device 112 obtains a set of homeshare data from the sensors 132 or from the mobile device 112 over a particular time period (e.g., one minute, 10 minutes, one hour, etc.), the smart device 134 and/or mobile device 112 may broadcast the transaction 500A to blockchain 502A to be included in a block, such as block 504A.

The transaction 500A may include various information regarding the homeshare data. For example, the transaction 500A may include a transaction ID and an originator such as the mobile device 112 (identified by a cryptographic proof-of-identity). The transaction 500A may also include identification information for the property 116 (a property ID), and the homeshare data including an indication of a time in which the homeshare data was generated and/or when a homeshare stay took place. Furthermore, the transaction 500A may include a cryptographic hash corresponding to the homeshare data. In another embodiment, the homeshare data is not stored as a cryptographic hash, but may be directly accessible in block 504A by an observer or other network participant.

It will be understood that the above disclosure is one example and does not necessarily describe every possible implementation. As such, it will be further understood that alternate embodiments may include fewer, alternate, and/or additional steps or elements.

### Exemplary Smart Contract State

As described above, a participant in the distributed ledger network such as a computing device associated with an insurance company, a property rental company, a regulatory organization, and/or another organization involved in determining a level of risk for a user and/or property may deploy smart contracts to the distributed ledger to generate a level of risk. In some embodiments, the organization involved in determining the levels of risk may deploy different smart contracts for each property and/or user to a different address on the blockchain. Accordingly, a computing device requesting a level of risk for a particular user may transmit the request to the address for the smart contract corresponding to the property and/or user in question. In this manner, the computing device may provide a first level of risk for a first user and a second level of risk for a second user.

FIG. 5B depicts an exemplary smart contract state 500B in a distributed ledger network for generating a level of risk in accordance with one aspect of the present disclosure. FIG. 5B may include a blockchain 502B, a block of transactions 504B, and a homeshare smart contract state 506B. A participant in the homeshare blockchain network may deploy a smart contract to establish a contract state 506B for a particular level of risk request. The deployed smart contract may expose methods and data to other participants in the homeshare blockchain network. Some of the data in the smart contract state may be private data that may only be altered by calling a method of the smart contract or only altered by authorized blockchain participants.

One way of altering the homeshare smart contract state 506B is to broadcast a transaction to the blockchain network. If the broadcast transaction satisfies consensus rules, network validators may include the transaction in a block 504B. Inclusion in the blockchain 502B of a transaction sending data to the smart contract may cause validating nodes to update a state database. As such, network participants may access a rich state mechanism to manage the analysis of the homeshare data, and ultimately to generate the level of risk.

Homeshare smart contract state 506B may include pieces of data to identify and track the request. For example, a contract owner may select a unique ID for the level of risk calculation such that subsequent transactions and data sent to the smart contract can identify the level of risk calculation by ID number. The contract owner may also specify an identity of the property 116 and identities of devices authorized to provide homeshare data for the property, such as the smart device 134 and/or the mobile device 112. In at least one embodiment, a computing device associated with the property 116, the smart device 134, and/or the mobile device 112 may be identifiable by cryptographic public keys assigned to the respective entities.

Subsequent data sent to the smart contract may include a message signed by private keys corresponding to the public keys identifying the smart device 134 and/or the mobile device 112 in the smart contract, thereby providing cryptographic proof that an authorized entity originated the transaction, such as an authorized smart device 134 and/or an authorized mobile device 112. The parties may solely manage the private and public keys to minimize the attack surface for any attackers that might attempt to forge a transaction (e.g., the parties generate public/private cryptographic key pairs offline and only provide the public key to other network participants). A party's private keys may be generated according to a securely stored seed value (e.g., on a piece of physical paper or multiple copies of a piece of paper) such that the private keys may be recovered in the case of a data loss.

The smart device 134 and/or the mobile device 112 may broadcast transactions that may include homeshare data to the blockchain 502B. Further, the smart device 134 and/or the mobile device 112 may transmit sensor data received from sensors 132. An entity may cryptographically sign the sensor data to provide cryptographic proof-of-identity that the sensor data came from a smart device 134 and/or mobile device 112 authorized to provide homeshare data for the property 116. Accordingly, the smart contract may compare the provided identity to a list of smart devices 134 and/or mobile devices 112 authorized to provide homeshare data for the property 116.

Another aspect of the smart contract state 506B is the smart contract data. Smart contract data may be comparable to the private and public data in an object created according to an object-oriented programming paradigm in that the system may directly update smart contract data from outside the object, or the system may update the smart contract data only in limited ways, such as by calling a method of the smart contract. The smart contract data may include homeshare metrics and/or key information which the system may generate based upon the homeshare data, such as a homeshare rental phase, controlling party, insurance policy, calculated customizable quote, and/or any other data indicative of the homeshare companies and/or user renting the property out during a relevant time period, as described herein.

In some embodiments, the smart contract may generate the level of risk based upon the smart contract data. For example, the level of risk may include homeshare data in accordance with the smart contract data. In some embodiments, the smart contract may transmit the generated level of risk to the requestor 114 or to an address on the blockchain 502B which is associated with the requestor 114.

In some embodiments, the smart contract may generate the level of risk based upon a homeshare company with the most advanced rental phase of a homeshare stay. For example, when a user rents the property 116 at phase 3 via Homeshare Company A, the smart contract may determine that an applicable policy for Homeshare Company A should control.

In further embodiments, a user may rent out the property 116 at multiple rental phases of the homeshare stay, and the smart contract may generate the level of risk proportionally to the determined responsibility. For example, the user may rent out the property at phase 3 for Homeshare Company A and phase 2 for Homeshare Company B. In the above example, Homeshare Company A may be responsible for ⅔ of the risk and Homeshare Company B may be responsible for ⅓. As such, the smart contract may determine the level of risk accordingly.

Depending on the embodiment, the smart contract may generate the level of risk based upon: a number of homeshare companies through which the user rents the property, historical accident data, location data, voice and/or audio data, digital satellite system (DSS) feed data, property state data, and/or any combination thereof.

It will be understood that the above disclosure is one example and does not necessarily describe every possible implementation. As such, it will be further understood that alternate embodiments may include fewer, alternate, and/or additional steps or elements.

### Exemplary Distributed Ledger Operations

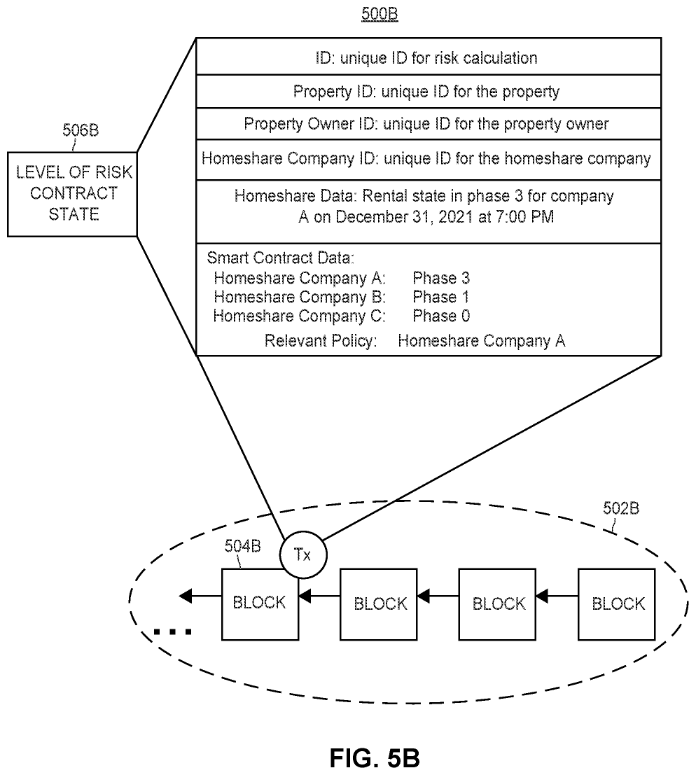

FIG. 6 is a flow diagram of an exemplary computer-implemented method 600 for aggregating homeshare data for properties and updating a distributed ledger maintained by a plurality of participants using the aggregated homeshare data. The method 600 may be implemented by one or more processors of a computing system such as a computing device representing property 116 or mobile device 112. Alternatively or additionally, the method 600 may be implemented by one or more processors of a distributed system such as system 100 and/or various components of system 100 as described with regard to FIG. 1 above, or otherwise implemented by one or more local or remote processors, servers, sensors, transceivers, memory units, or other electronic or electrical components.

At block 602, the computer system 100 may identify one or more homeshare companies for which a user offers to rent out at least part of a real property during a time period. For example, the user may rent out a first room in a house via a first homeshare company (Homeshare Company A) and a second room in the house via a second homeshare company (Homeshare Company B). Similarly, the user may rent out the entire house via both Homeshare Company A and Homeshare Company B. In some embodiments, the report application 172 may interface with, may include, or may be one or more homeshare applications. Depending on the embodiment, the system 100 may identify the homeshare companies based upon the presence of an application on a user mobile device, the existence of a renter account for the user, the operation of an application on a user mobile device during the time period, or any other similar metric.

At block 604, the computer system may identify a phase (e.g., rental phase) of a homeshare stay during the time period for each of the identified homeshare companies. In some embodiments, the rental phase of the homeshare stay may refer to a particular portion of the stay as apportioned in terms of the status of the rental property. For example, a stay may be split into four rental phases, labelled phase 0, phase 1, phase 2, and phase 3. In such an example, phase 0 may refer to a homeshare application being entirely disabled, phase 1 may refer to a homeshare application searching for potential rentees (e.g., renters looking to rent the property from the user), phase 2 may refer to a homeshare application having identified a rentee that has paid a down payment on the rental property, and phase 3 may refer to the rentee occupying the rental property. Depending on the embodiment, the system 100 may identify the rental phase based upon data from the appropriate homeshare application, a renter mobile device, a rentee mobile device, sensors in the property, smart devices on the property, or a similar method. In some embodiments, the homeshare company with the highest rental phase may be the active homeshare company, and the relevant rental phase for the time period may be the rental phase of the active homeshare company

Depending on the embodiment, the user may rent the property for multiple homeshare companies and the identified rental phases may reflect the rental phase for each individual homeshare company. For example, if a user is renting property via both Homeshare Company A and Homeshare Company B, then the user may simultaneously be in phase 3 for Homeshare Company A (e.g., a rentee is occupying the property) and phase 2 for Homeshare Company B (e.g., another rentee has placed a down payment on the rental property). As such, the system 100 can determine that the user is in the respective rental phase for each homeshare company. In further embodiments, when the system 100 cannot determine the rental phase for a homeshare company, the system 100 may set the rental phase to phase 0 by default.

Although the application refers to homeshare companies, it will be understood that the term “homeshare companies” may encompass alternative practices or companies commonly practiced alongside or by homeshare companies. For example, a homeshare company in the current context may refer to a homeshare rental service, but may also refer to a more traditional timeshare property, a parking space, a storage unit, or any other similar service and/or practice.

At block 606, the system 100 may determine homeshare data for a user, where the homeshare data may include an indication of the identified homeshare companies and the rental phase of the homeshare stay for each of the homeshare companies. In some embodiments, the homeshare data may include other information gathered from the user and/or homeshare companies, such as property state data and/or item state data. Property state data and item state data as used herein refer to a tangible condition of the property or item in question (e.g., damaged walls, scuffed floors, rickety furniture, etc.). In some such embodiments, the homeshare data further may include any or all of: user profile name, user address, homeshare location data, homeshare timestamp data, homeshare profile rating data, homeshare application message data, historical homeshare rental phase data, property sensor data, and/or other homeshare profile data. Depending on the embodiment, the system 100 may determine the homeshare data based upon data gathered from a mobile device 112 of the user or another similar data stream, such as sensor data or a smart device 134.

In further embodiments, the system 100 may make various determinations based upon the collected homeshare data. For example, the system 100 may determine based upon the homeshare profile rating data and/or other homeshare data that the property consistently has reports of the same problem (e.g., a malfunctioning lock, a broken chair, etc.). Depending on the embodiment, the system 100 may provide such information to rentees and/or include the information in the transaction generated for the blockchain. In further embodiments, the system 100 may use such information in calculating a level of risk for the user and/or property as described in more detail with regard to FIG. 7 below.

At block 608, the system 100 may generate a transaction including a representation of the homeshare data. The system 100 further may store the transactions on the distributed ledger, such as distributed ledger 310 or property homeshare ledger 212. In some embodiments, the transaction may resemble the transaction illustrated in FIG. 5A. At block 610, the system 100 may transmit the transaction to at least one other participant maintaining the ledger. In some embodiments, the system 100 or a component of the system 100 may use the homeshare data on the distributed ledger to calculate a level of risk. In some embodiments, the level of risk may be based upon the rental phase of the homeshare stay. The system 100 may use a variety of methods to calculate the level risk as described in more detail with regard to FIG. 7 below.

It will be understood that the above disclosure is one example and does not necessarily describe every possible implementation. As such, it will be further understood that alternate embodiments may include fewer, alternate, and/or additional steps or elements.

FIG. 7 is a flow diagram of an example method 700 for aggregating homeshare data for properties and updating a distributed ledger maintained by a plurality of participants using the aggregated homeshare data. The method 700 may be implemented by one or more processors of a computing system such as property 116 or mobile device 112. Alternatively or additionally, the method 700 may be implemented by one or more processors of a distributed system such as system 100 and/or various components of system 100 as described with regard to FIG. 1 above.

At block 702, the system 100 may monitor a distributed ledger, such as ledger 310 or property homeshare ledger 212. The system 100 may monitor the distributed ledger for an indication of homeshare data. In some embodiments, the system 100 may detect an indication of homeshare data in response to the ledger being updated with homeshare data. In other embodiments, the system 100 may detect an indication of homeshare data by receiving a notification from the blockchain or from the network 120. The homeshare data may include a rental phase of a homeshare stay for each homeshare company during a time period.

In some embodiments, the homeshare data may include other information gathered from the user and/or homeshare companies. For example, in some such embodiments, the homeshare data further may include any or all of: user profile name, user address, homeshare location data, homeshare timestamp data, homeshare profile rating data, homeshare application message data, historical homeshare rental phase data, property sensor data, and/or other homeshare profile data. Similarly, the homeshare data may include particular information on the user based upon a user rating, such as a responsibility score or other comment and/or critique-based metrics.

At block 704, the system 100 may determine a level of risk for the user during the time period. In some embodiments, the system 100 may determine the level of risk based upon the rental phase of the homeshare stay for each homeshare company during the time period. For example, the system 100 may determine that the rental phase of the homeshare stay is phase 3 for Homeshare Company A during a first part of a time period. As such, the system 100 may determine that an insurance policy for Homeshare Company A applies during the first part of the time period. Similarly, the system 100 may determine that, during a second part of the time period, the rental phase of the homeshare stay is phase 0 for all homeshare companies, and an insurance policy for the user applies. In further embodiments, the system 100 may determine the level of risk further based upon the homeshare data, such as on a user rating, responsibility score, and/or other critique-based metrics.

At block 706, the system 100 may then calculate an overall level of risk for the user and/or property 116 when the user is renting out the property 116. The overall level of risk may be based upon the homeshare data and the level of risk for the user during the time period. For example, the system 100 may determine that the property 116 is only inhabited, used, and/or activated while in phase 3 for at least one homeshare company, and therefore has a low overall level of risk. Similarly, the system 100 may determine that the user is covered by a personal insurance policy while the property 116 is outside of phase 3. Alternatively, the system 100 may determine that the user sometimes inhabits and/or uses the property outside of phase 3 and is not covered by a personal policy. The system 100 may then determine to offer a customizable quote to the user.

In further embodiments, the system 100 may determine that a user is currently using the property 116 outside of phase 3 and is uncovered by a policy and/or has a high overall level of risk score. As such, the system 100 may offer a customizable quote to the user. For example, the system 100 may determine that a rental phase of the homeshare stay changes from 3 to 0 and may subsequently cause a mobile device to display a message indicating that the user is no longer covered by a homeshare company insurance policy. In further embodiments, the system 100 may cause a mobile device to offer a pay-per-day or similarly temporary insurance policy quote in response to the determination.

Similarly, in other embodiments, the system 100 may determine that the user is renting part of the property 116 via multiple homeshare companies and may determine the level of risk based upon the rental phases for each homeshare company. For example, the system 100 may determine that the rental phase of the homeshare stay is phase 3 for Homeshare Company A and phase 2 for Homeshare Company B during a first part of a time period, phase 3 for Homeshare Company B during a second part of the time period, and phase 0 for all homeshare companies during a third part of the time period. Similarly, the system 100 may determine that there is overlap between rental phases of the different homeshare companies. For example, the system 100 may determine that a rentee renting through Homeshare Company A leaves the same day that a rentee renting through Homeshare Company B arrives. Depending on the embodiment, the system 100 can determine the level and distribution of risk proportionally to the length of time each company is on phase 3, proportionally to the rental phase each company is on during each part, based upon a majority time during the time period, based upon the existence or lack thereof of rental phase overlap or some other method.

In further embodiments, the system 100 may calculate the level of risk and/or the overall level of risk and may determine a customizable quote such as a pay-per-day quote based upon the level of risk and/or overall level of risk as well as a cost for underwriting due to risk factors. For example, in some embodiments, the customizable quote may be based upon any of: a number of homeshare companies via which the user rents the property 116, historical accident data, location data, voice and/or audio data, digital satellite system (DSS) feed data, property state data, other potential risk data, and/or any combination thereof.

In still other embodiments, the system 100 may determine the level of risk and/or a customizable quote using a smart contract. For example, the smart contract may receive homeshare data as described in FIG. 5B above and may generate a level of risk and/or overall level of risk based upon the homeshare data. In some embodiments, the smart contract may transmit the generated level of risk to the requestor 114 or to an address on the blockchain which is associated with the requestor 114.

In some embodiments, the smart contract may generate the level of risk based upon a homeshare company with the most advanced rental phase of a homeshare stay. For example, when a user is at phase 3 for a stay for Homeshare Company A, the smart contract may determine that an applicable policy for Homeshare Company A should control.

In further embodiments, a user may be renting out a portion or multiple portions of the property 116 for different homeshare companies at multiple rental phases, and the smart contract may generate the level of risk proportionally to the determined responsibility. For example, the property may be at phase 3 for Homeshare Company A and phase 2 for Homeshare Company B. In the above example, Homeshare Company A may be responsible for ⅔ of the risk and Homeshare Company B may be responsible for ⅓. As such, the smart contract may determine the level of risk accordingly.

Additionally or alternatively to calculating the level of risk, the system 100 can verify a controlling party and/or generate a settlement quote for an accident on the property 116. In some such embodiments, the system 100 may monitor the distributed ledger for an indication of an accident. Depending on the embodiment, the system 100 may detect an indication of an accident in response to the ledger being updated with homeshare data, by receiving a notification from the blockchain 118, by receiving a notification from the network 120, or through a similar technique. The indication may include a user and a time period, and may include other information gathered from the user, homeshare companies, smart device 134, sensors 132, mobile device 112, and/or computing device 117 associated with the property 116 as detailed in FIG. 1 above. In some embodiments, the system 100 may automatically transmit an indication of the accident to a medical and/or emergency facility, such as a hospital.

In some such embodiments, the homeshare data may include a user profile name, user address, property data, homeshare timestamp data, homeshare profile rating data, homeshare application message data, historical homeshare rental phase data, property sensor data, and/or other homeshare profile data. The homeshare data may also include accident data, such as image data, property state data, historical condition data, sensor data, etc. Depending on the embodiment, the system 100 may transmit an indication to a computing and/or mobile device of the user to prompt the user and/or a rentee to take pictures and upload the image data.

When verifying a controlling party, the system 100 may make a determination based upon the homeshare data and/or any accident data. The controlling party may be any of the user, the rentee, or one of the homeshare companies. In some embodiments, the system 100 may verify the controlling party based upon the rental phase of the homeshare stay during the accident. For example, the system may determine that, because the property was at phase 3 for Homeshare Company A, Homeshare Company A was the controlling party. In some embodiments, the system 100 may compare the determined controlling party to a listed party according to the accident data or from the indication of the accident. If the system 100 successfully verifies the controlling party, then the system 100 may generate a settlement quote. If the system 100 does not successfully verify the controlling party, then the system 100 may replace the controlling party with a determined party or may notify personnel to make a determination.

In some embodiments, the system 100 may then transmit a message, such as an e-mail message, text message, SMS message, a message pushed from a phone application, etc. In some such embodiments, the system 100 may transmit the message to the user, the homeshare company or companies, the rentees, and/or other identified parties. In further embodiments, the system 100 may only transmit the message to homeshare companies above a predetermined threshold (e.g., all homeshare companies operating at or above phase 2). In other embodiments, the system 100 may only transmit the message to the user and/or owner, the rentees, and the controlling party. The message may include information related to claims processing, insurance processing, settlement quotes, party responsibility, etc.

After verifying the controlling party, the system 100 may generate a settlement quote for the accident based upon the homeshare data. For example, in some embodiments, the settlement quote may be based upon the rental phase of the homeshare stay and/or the controlling party. In some such embodiments, the settlement quote may be allocated entirely to the controlling party. In other such embodiments, the settlement quote may be allocated proportionally to the rental phase of the homeshare stay for each homeshare company. For example, if the property is rented at phase 3 for Homeshare Company A and phase 2 for Homeshare Company B, a majority of the settlement quote may be generated according to an insurance policy for Homeshare Company A and to a lesser degree according to an insurance policy for Homeshare Company B.

In some embodiments, the system 100 may generate and transmit a transaction including a representation of the settlement quote to participants maintaining the distributed ledger. In such embodiments, the system 100 may transmit the transaction to an address that stores a smart contract on the distributed ledger. The smart contract may then generate a payment based upon the settlement quote, similar to the smart contract as described in FIG. 5B above. In some such embodiments, a computing device at the address may automatically pay out the payment based upon the smart contract. In other embodiments, a computing device may require authorization from insurance personnel before paying out the payment.

In further embodiments, the system 100 may calculate the settlement quote based upon the controlling party as well as the accident data. For example, in some embodiments, the settlement quote may be based upon any of: image data, location data, voice and/or audio data, digital satellite system (DSS) feed data, property state data, other party damage data, recorded damage data, and/or similar types of data.

In still other embodiments, the system 100 may determine the settlement quote using a smart contract. For example, the smart contract may receive homeshare data and/or accident data as described in FIG. 5B above and may generate a settlement quote based upon the homeshare data. In some embodiments, the smart contract may transmit the generated settlement quote to the requestor 114 or to an address on the blockchain which is associated with the requestor 114. In some embodiments, the smart contract may generate the settlement quote based upon a homeshare company with the most advanced rental phase. For example, when a property is at phase 3 for Homeshare Company A, the smart contract may determine that an applicable policy for Homeshare Company A should control.

In further embodiments, a user may rent property 116 out for multiple homeshare companies at multiple rental phases, and the smart contract may generate the settlement quote proportionally to the determined responsibility. For example, the property 116 may be at phase 3 for Homeshare Company A and phase 2 for Homeshare Company B. In the above example, Homeshare Company A may be responsible for ⅔ of the risk and Homeshare Company B may be responsible for ⅓. As such, the smart contract may determine the settlement quote accordingly.

It will be understood that the above disclosure is one example and does not necessarily describe every possible implementation. As such, it will be further understood that alternate embodiments may include fewer, alternate, and/or additional steps or elements.

With the foregoing, a user may opt-in to a rewards, insurance discount, or other type of program. After the user provides their affirmative consent, an insurance provider remote server may collect data from the user's mobile device, smart home device, smart vehicle, wearables, smart glasses, or other smart devices—such as with the customer's permission or affirmative consent. The data collected may be related to smart home functionality, homeshare data, accident data, and/or insured assets before (and/or after) an insurance-related event, including those events discussed elsewhere herein. In return, risk averse insureds, home owners, or home or apartment occupants may receive discounts or insurance cost savings related to home, renters, auto, personal articles, and other types of insurance from the insurance provider.

In one aspect, smart or interconnected home data, homeshare data, accident data, and/or other data, including the types of data discussed elsewhere herein, may be collected or received by an insurance provider remote server, such as via direct or indirect wireless communication or data transmission from a smart home device, mobile device, smart vehicle, wearable, smart glasses, or other customer computing device, after a customer affirmatively consents or otherwise opts-in to an insurance discount, reward, or other program. The insurance provider may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, vehicles, or rentee belongings, and/or (ii) home or apartment rentees and/or occupants.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

In addition, use of “a” or “an” is employed to describe elements and components of the embodiments herein. This is done merely for convenience and to give a general sense of the invention. This description should be read to include one or at least one and the singular also may include the plural unless it is obvious that it is meant otherwise.

Upon reading this disclosure, those of skill in the art will appreciate still additional alternative structural and functional designs for providing feedback to owners of properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generating transactions based upon homeshare data for a user and updating a distributed ledger maintained by a plurality of participants, the method comprising:
identifying, by one or more processors, a homeshare company through which a user rents out at least part of a real property during a time period;
identifying, by the one or more processors, a rental phase of the at least part of the real property for the homeshare company during the time period;
determining, by the one or more processors, homeshare data for the user, wherein the homeshare data includes the rental phase of the at least part of the real property for the homeshare company during the time period;
generating, by the one or more processors, a transaction including a representation of the homeshare data, wherein the transaction is stored in the distributed ledger; and
transmitting, by the one or more processors, the transaction to at least one other participant of the plurality of participants maintaining the distributed ledger, wherein the distributed ledger maintains a record of users and the homeshare company for which each user rents out at least part of a respective real property, and wherein homeshare data from the distributed ledger for the user is used to calculate a level of risk when the user is renting out the at least part of the real property.

2. The computer-implemented method of claim 1, further comprising:
retrieving, from a computing device of a renter of the at least part of the real property, renter data, wherein the renter data is indicative of a property state of the at least part of the real property;
wherein the transaction further includes a representation of the renter data.

3. The computer-implemented method of claim 1, wherein the homeshare company is a first homeshare company of a plurality of homeshare companies and the homeshare data includes a rental phase of the at least part of the real property for each homeshare company of the plurality of homeshare companies.

4. The computer-implemented method of claim 1, wherein the homeshare company is a plurality of homeshare companies, and further comprising:
determining, based upon the homeshare data, an active homeshare company, wherein the active homeshare company is the homeshare company through which the user rents out the at least part of the real property during the time period;
wherein the rental phase is a rental phase of the active homeshare company.

5. The computer-implemented method of claim 1, further comprising:
adding the transaction to a block of transactions;
solving a cryptographic puzzle based upon the block of transactions;
adding the solution to the cryptographic puzzle to the block of transactions; and
transmitting the block of transactions to at least one other participant in the distributed ledger network.

6. The computer-implemented method of claim 1, wherein generating the transaction includes generating a transaction including a cryptographic hash value corresponding to the homeshare data, and further comprising:
transmitting the homeshare data to a server computing device that calculates the level of risk based upon the homeshare data.

7. The computer-implemented method of claim 1, wherein transmitting the transaction includes transmitting, by the one or more processors, the transaction to an address that stores a smart contract on the distributed ledger, wherein the smart contract calculates the level of risk based upon the homeshare data collected over the period of time.

8. A computing device for generating transactions based upon homeshare data for a user and updating a distributed ledger maintained by a plurality of participants, the computing device comprising:
one or more processors;
a communication unit; and
a non-transitory computer-readable medium coupled to the one or more processors and the communication unit and storing instructions thereon that, when executed by the one or more processors, cause the computing device to:
identify a homeshare company through which a user rents out at least part of a real property;
identify a rental phase of the at least part of the real property for the homeshare company during the time period;
determine homeshare data for the user, wherein the homeshare data includes the rental phase of the at least part of the real property for the homeshare company during the time period;
generate a transaction including a representation of the homeshare data, wherein the transaction is stored in the distributed ledger; and
transmit the transaction to at least one other participant of the plurality of participants maintaining the distributed ledger, wherein the distributed ledger maintains a record of users and the homeshare company for which each user rents out at least part of a respective real property, and wherein homeshare data from the distributed ledger for the user is used to calculate a level of risk when the user is renting out the at least part of the real property.

9. The computing device of claim 8, wherein the non-transitory computer-readable medium further stores instructions that, when executed by the one or more processors, cause the computing device to:
retrieve, from a computing device of a renter of the at least part of the real property, renter data, wherein the renter data is indicative of a property state of the at least part of the real property;
wherein the transaction further includes a representation of the renter data.

10. The computing device of claim 8, wherein the homeshare company is a first homeshare company of a plurality of homeshare companies and the homeshare data includes a rental phase of the at least part of the real property for each homeshare company of the plurality of companies.

11. The computing device of claim 8, wherein the homeshare company is a plurality of homeshare companies, and wherein the non-transitory computer-readable medium further stores instructions that, when executed by the one or more processors, cause the computing device to:
determine, based upon the homeshare data, an active homeshare company, wherein the active homeshare company is the homeshare company through which the user rents out the at least part of the real property during the time period;
wherein the rental phase is a rental phase of the active homeshare company.

12. The computing device of claim 8, wherein the non-transitory computer-readable medium further stores instructions that, when executed by the one or more processors, cause the computing device to:
add the transaction to a block of transactions;
solve a cryptographic puzzle based upon the block of transactions;
add the solution to the cryptographic puzzle to the block of transactions; and
transmit the block of transactions to at least one other participant in the distributed ledger network.

13. The computing device of claim 8, wherein generating the transaction includes generating a transaction including a cryptographic hash value corresponding to the homeshare data, and wherein the non-transitory computer-readable medium further stores instructions that, when executed by the one or more processors, cause the computing device to:
transmit the homeshare data to a server computing device that calculates the level of risk based upon the homeshare data.

14. The computing device of claim 8, wherein transmitting the transaction includes transmitting the transaction to an address that stores a smart contract on the distributed ledger, wherein the smart contract calculates the level of risk based upon the homeshare data collected over the period of time.

15. A computer-implemented method of calculating a level of risk using aggregated homeshare data from a distributed ledger maintained by a plurality of participants, the method comprising:
monitoring, by one or more processors, the distributed ledger for an indication of homeshare data, the homeshare data including a rental phase of at least part of a real property that a user rents out through a homeshare company during a time period;
determining, by the one or more processors and based upon the rental phase during the time period for the homeshare company, a level of risk for the user during the time period; and
calculating, by the one or more processors, an overall level of risk for the user when the user is renting out the at least part of the real property based upon the homeshare data and the level of risk for the user during the time period.

16. The computer-implemented method of claim 15, wherein the level of risk is attributable to the homeshare company when the rental phase of the at least part of the real property indicates the user is renting out the at least part of the real property through the homeshare company and is otherwise attributable to the user.

17. The computer-implemented method of claim 15, wherein the homeshare company is a first homeshare company of a plurality of homeshare companies and the homeshare data includes a rental phase of the at least part of the real property for each homeshare company of the plurality of homeshare companies.

18. The computer-implemented method of claim 15, further comprising:
determining, based upon the homeshare data, an active homeshare company, wherein the active homeshare company is the homeshare company through which the user rents out the at least part of the real property during the time period; and
wherein the overall level of risk is further based upon the active homeshare company.

19. The computer-implemented method of claim 15, further comprising:
retrieving, from a computing device of a renter of the at least part of the real property, renter data, wherein the renter data is indicative of a property state of the at least part of the real property;
wherein the overall level of risk is further based upon the renter data.

20. The computer-implemented method of claim 15, further comprising:
monitoring the distributed ledger for an indication for an indication of renter data from a renter of the at least part of the real property, wherein the renter data is indicative of a property state of the at least part of the real property;
wherein the overall level of risk is further based upon the renter data.
